(19) United States
(12) Patent Application Publication
(10) Pub. No.: US 2006/0237362 A1
(43) Pub. Date: Oct. 26, 2006

(54) Wastewater solids strainer apparatus for plumbing drain systems in commercial kitchen facilities

(76) Inventor: Bret M. Weymouth, Newberg, OR (US)

Correspondence Address: OLSON AND OLSON, 5412 SE FOSTER ROAD, PORTLAND, OR, 97206, US

(21) Appl. No.: 11/407,755

(22) Filed: Apr. 19, 2006

Related U.S. Application Data
(60) Provisional application No. 60/673,526, filed on Apr. 21, 2005.

(51) Int. Cl. B01D 21/02

(52) U.S. Cl. 210/532.1; 210/299

(57) ABSTRACT

A wastewater solids strainer apparatus provides a tank-type container housing member having an interior cavity having an upper, solids separation and gravitation chamber and an underlying, lower, semi-solid material collecting sump chamber arranged to collect heavier-than-water solids and semi-solids settling by gravity from a volume of water maintained in the housing, a solids screen for collecting solid particles entering the housing through an inlet, and a housing outlet arranged to discharge wastewater from only the top portion of the volume of wastewater in the housing.

This application claims benefit under 35 U.S.C. 119(e) of the priority filing of U.S. Provisional application Ser. No. 60/673,526, Filed 21 Apr. 2005.

### BACKGROUND OF THE INVENTION

This invention relates generally to commercial kitchens and food preparation facilities having wastewater drain systems that include grease trap devices arranged to receive wastewater and skim and remove grease and oils therefrom prior to discharging the wastewater into the municipal sewer system, the invention relating more particularly to the provision of an apparatus for straining and removing solids and viscous semi-solid materials from wastewater passing from the drains of rinse sinks and other wastewater sources prior to passage of the wastewater into such grease trap devices of the facility.

In commercial kitchens and food preparation facilities the wastewater plumbing systems are typically arranged to direct the wastewater discharge from rinse sinks, food preparation sinks, dishwashers and other sources of wastewater through grease trap devices which remove grease and oils from the wastewater prior to discharge into the municipal sewer systems serving the facility. These grease trap devices are typically required by the municipalities which provide the sewer systems servicing the community. While these required grease trap devices are generally effective in their intended purpose of removing greases, fats, and oils from the wastewater passing therethrough, their efficiency and effectiveness requires their being continually maintained in a condition that allows for proper wastewater flow therethrough from inlet to outlet.

However, as is well understood by those skilled in the restaurant and large-scale food preparation industry, the wastewater particularly from food preparation sinks and rinse sinks, besides being ladened with greases, fats and oils, carries a significant amount of solid particles and semi-solid materials with it into the plumbing system. These materials include such solids as food particles, fine solids such as coffee grounds, cooked frying and baking coatings, and innumerable other solid materials as well as semi-solid, viscous materials such as uncooked or raw cake, pancake, waffle and frying batters, baking batters and such. Additionally, these sinks in commercial food preparation facilities often include garbage disposers associated with their drain outlets which permit the introduction of solid materials into the drain system which would otherwise discarded manually into a waste receptacle.

Accordingly, it will be appreciated that all of these materials passing into the sink drain line along with the grease, fat and oil-laden wastewater passes into the grease trap apparatus, whereupon the grease, fats and oils, being inherently lighter-than-water are allowed to float to the top portion of the water level maintained in the grease trap apparatus while the heavier-than-water solids and semi-solid viscous materials sink to the bottom of the grease trap apparatus and there accumulate over time. The grease trap apparatus, as is well known, provides for the substantially floating greases and oils to be skimmed from the upper portion of the water within the apparatus and removed for discard in prescribed manner.

However, accumulated solid materials collecting in the bottom of the trap must be removed periodically from the grease trap apparatus in order to assure its proper operation and against clogging of the trap. Such clogging would result in drainage backups requiring expensive cleanups and worse, cause sanitary sewer overflows in which discharged sewage reaches free flowing waterways, etc. with the result of potential health risks and environmental damage. Depending on the size and output of the food preparation facility, and depending upon the size of the particular grease trap apparatus associated therewith, routine cleaning maintenance operations to remove accumulated solid materials may be required to be done on a daily to weekly basis. These operations entail the very unpleasant task of manual cleanings of the grease trap cavity, or pumping operations contracted with an outside vendor. In either case, these operations involve time and significant expense in the ongoing operation of the kitchen facility.

### SUMMARY OF THE INVENTION

In its basic concept this invention provides a wastewater solids strainer apparatus in the form of a separation and settling tank housing structure having a substantially hollow interior cavity arranged to maintain a predetermined level of wastewater passing therethrough from a housing inlet to a housing outlet, the interior cavity of the housing being arranged with an upper, solids separation and settling chamber portion and an underlying, sump-type solids and semi-solids collection chamber open to the bottom of the upper chamber and arranged to collect heavier-than-water material settling by gravity from the wastewater contained within the interior cavity of the housing, the upper chamber including a removable mesh screen solids collection member arranged to capture, confine, collect and facilitate disposal of solid particles carried into the interior cavity with wastewater entering through the housing inlet, the housing outlet arranged in the upper chamber for discharge of wastewater from the interior of the housing from only the uppermost portion of the wastewater level maintained in the interior of the tank housing, the solids collection sump chamber being specifically arranged for facilitated removal and discard of collected material as periodically needed.

It is by virtue of the foregoing basic concept that the principal object of this invention is achieved; namely, the provision of a wastewater solids strainer apparatus which separates and removes solid particles and semi-solid, viscous materials from wastewater passing therethrough for discharge of wastewater that is substantially free of solid particles and heavier-than-water solid and semi-solid viscous materials carried therewith.

Another object of this invention is the provision of a wastewater solids strainer apparatus of the class described which substantially and significantly reduces the passage of solids materials into grease trap devices and consequent accumulation therein, thereby greatly increasing the duration of efficient operation of the grease trap assembly between maintenance operations, greatly reducing the frequency of maintenance operations for the cleaning or pumping of the grease trap assembly, and thereby also greatly reducing the corresponding time and expense involved in the ongoing maintenance of the grease trap assembly.

Another object and advantage of this invention is the provision of a wastewater solids strainer apparatus of the class described which provides for easy, expedited disposal of solid particles collected by the mesh screen collection apparatus.

Another object and advantage of this invention is the provision of a wastewater solids strainer apparatus of the class described which provides for the simple, quick and facilitated removal and collection of the semi-solid, viscous materials collected in the sump chamber either manually by provision of a removable, lift-out collection container provided in the sump chamber, or alternatively if desired, by provision of a powered pump apparatus communicating with the interior of the sump chamber and operable on a periodic basis to pump collected semi-solid materials out of the collection sump chamber for discard.

Yet another object and advantage of this invention is the provision of a wastewater solids strainer apparatus of the class described which is of simplified construction for economical manufacture, installation and reliability of operation.

The foregoing and other objects and advantages of the present invention will appear from the following detailed description, taken in connection with the accompanying drawings of preferred embodiments.

### BRIEF DESCRIPTION OF THE DRAWINGS

FIG. 1 is a fragmentary front vertical elevational view of a first embodiment of a wastewater solids strainer apparatus embodying features of the present invention and shown in the form of a floor-supported assembly having an inlet communicating with the drain of a rinse sink and an outlet communicating with the inlet of a commercial grease trap apparatus.

FIG. 2 is a fragmentary front vertical elevational view of the strainer apparatus of FIG. 1 shown on a slightly enlarged scale and having the front wall of the strainer apparatus cut away in order to show internal detail of the strainer apparatus.

FIG. 3 is a fragmentary, sectional vertical elevational view through a second embodiment of a wastewater strainer apparatus embodying the features of this invention and showing internal structural detail thereof.

### DESCRIPTION OF THE PREFERRED EMBODIMENTS

This invention provides an apparatus arranged for straining and removing solid food and other particles as well as viscous semi-solid, heavier-than-water materials from wastewater passing primarily from the drains of one or more rinse sinks, food preparation sinks and other sources of wastewater in commercial kitchens and other food preparation facilities before the wastewater enters into a grease trap assembly prior to ultimate discharge of the wastewater from the commercial facility and into the municipal sewer system servicing the facility. These grease trap assemblies, which are required in most municipalities, basically provide a tank enclosure arranged to maintain a predetermined volume of wastewater therein as wastewater passes therethrough from inlet to outlet and provide a low turbulence space for the lighter-than-water greases, fats and oils to rise to the surface of the wastewater contained in the trap whereupon the floating grease, fat and oils may be effectively skimmed from the wastewater and discarded.

Unfortunately, while these grease traps provide the proper, low turbulence environment to allow the greases, fats and oils to float to the surface of the wastewater, they also allow lighter-than-water solid particles to float to the top surface of the wastewater where they of course will accumulate. Further, this low turbulence area also allows the heavier-than-water solids and semi-solid viscous materials contained in the wastewater to gravitate settle by gravity to the bottom of the grease trap apparatus and there accumulate over time. This accumulation of solid and semi-solid materials is extremely disadvantageous to the ongoing efficient operation and maintenance of these grease trap assemblies.

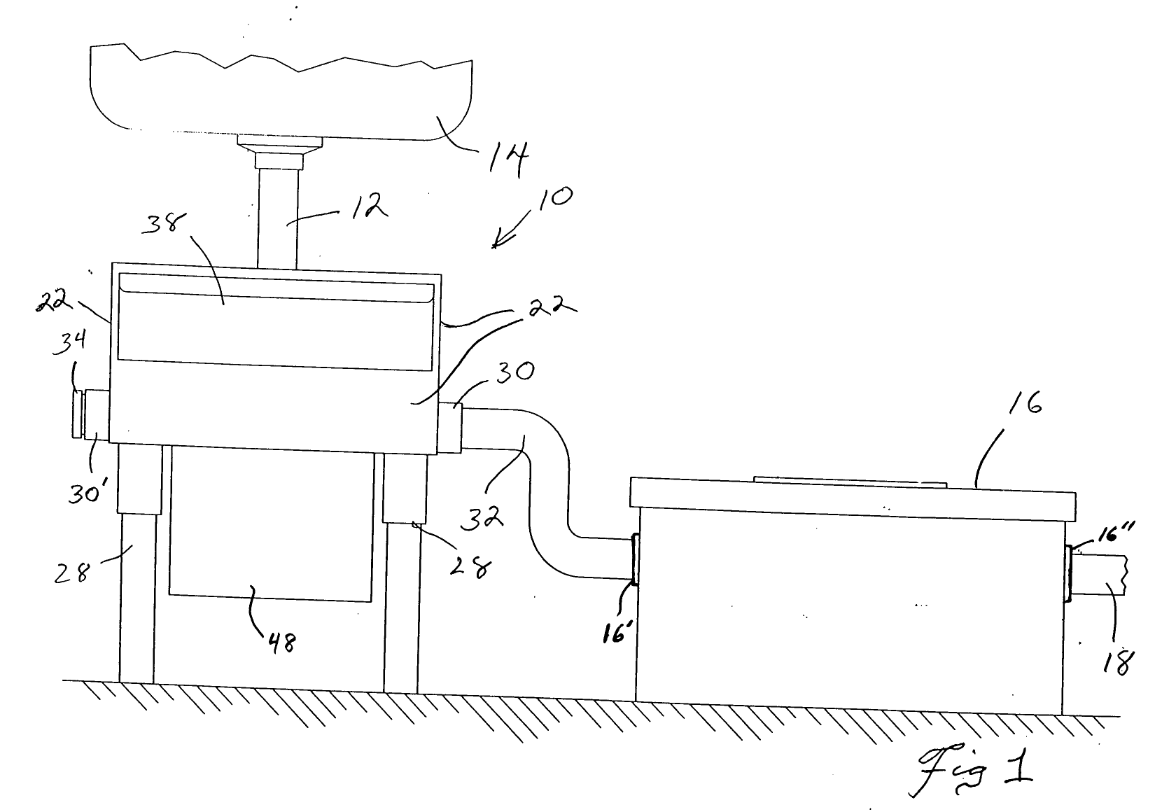

FIG. 1 illustrates a first embodiment of a solids strainer apparatus 10 embodying features of this invention, the apparatus being disposed in the wastewater drain system of a restaurant kitchen or other food preparation facility. In the particular embodiment illustrated herein, the strainer apparatus 10 is installed in the plumbing drain system of the facility intermediate the drain pipe 12 of one or more wastewater sources, represented herein as rinse sink 14, and a grease trap apparatus 16 typically provided for extracting grease, fats and oils from the wastewater prior to discharge of the wastewater through a drain pipe 18 and into the municipal sewer system. These grease trap devices and their functioning are well known in the art and therefore need not be explained in any further detail herein.

As illustrated, the solids strainer apparatus 10 of this invention may as shown comprise a substantially self-contained unit in the form of a tank type container housing having a substantially hollow, wastewater containing interior cavity 20 forming a basin-like first, upper, solids and semi-solids separation and settling chamber 20 within enclosing container housing side walls 22, bottom wall 24 and, in this embodiment, open top end 26. Alternatively, the open top end of the container may be closed with a top wall or removable lid member (not shown) provided with an opening communicating the sink drain pipe 12 with the interior of the cavity. In the particular embodiments shown, the container housing is supported on an underlying floor surface of the facility by upstanding leg members 28 that may if desired be arranged to provide for vertical adjustment of the container assembly on the underlying floor surface as may be needed for installation of the apparatus within the space available relative to existing wastewater drain pipe arrangements and different plumbing systems of various facilities. It is to be understood however that alternatively, the container housing could be arranged for in-floor mounting or other forms of support in a facility as well.

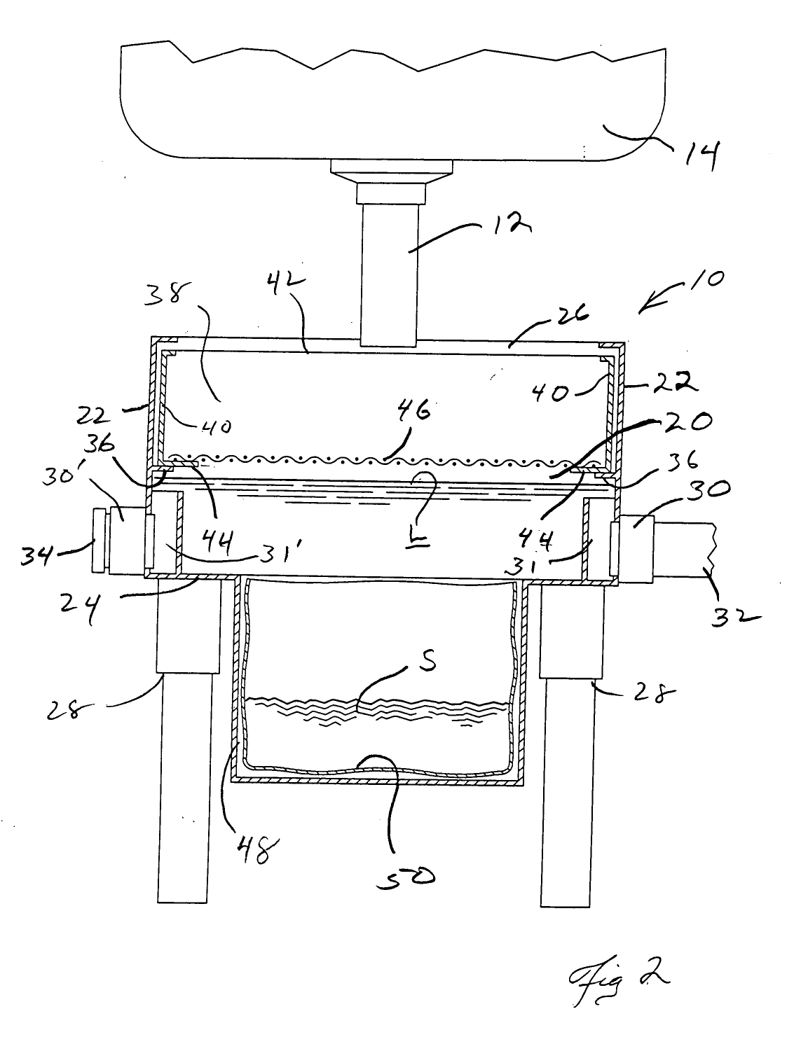

As seen in FIG. 1 and in the sectional view of FIG. 2 through the strainer apparatus 10 showing internal detail, the first, upper basin-like chamber 20 is provided with a wastewater outlet 30 positioned, in this particular embodiment, through a side wall 22 of the upper separation chamber 20 adjacent the bottom wall 24 thereof. This outlet 30 is arranged to communicate the interior of the upper chamber 20 of the container with a wastewater discharge pipe 32 which communicates with the inlet 16′ of a grease trap apparatus 16, the outlet 16″ of which discharges through a drain pipe 18 to the municipal sewer system, as is well understood in the art.

If desired, additional wastewater outlets 30′ may be provided as shown in order to accommodate alternative attachment locations for discharge pipes 32 for facilitating installation of the apparatus in different plumbing situations and discharge arrangements as will be found in different kitchen facilities. Cap plug members 34 are provided to seal any unused outlet 30′ as will be readily evident to those skilled in the art.

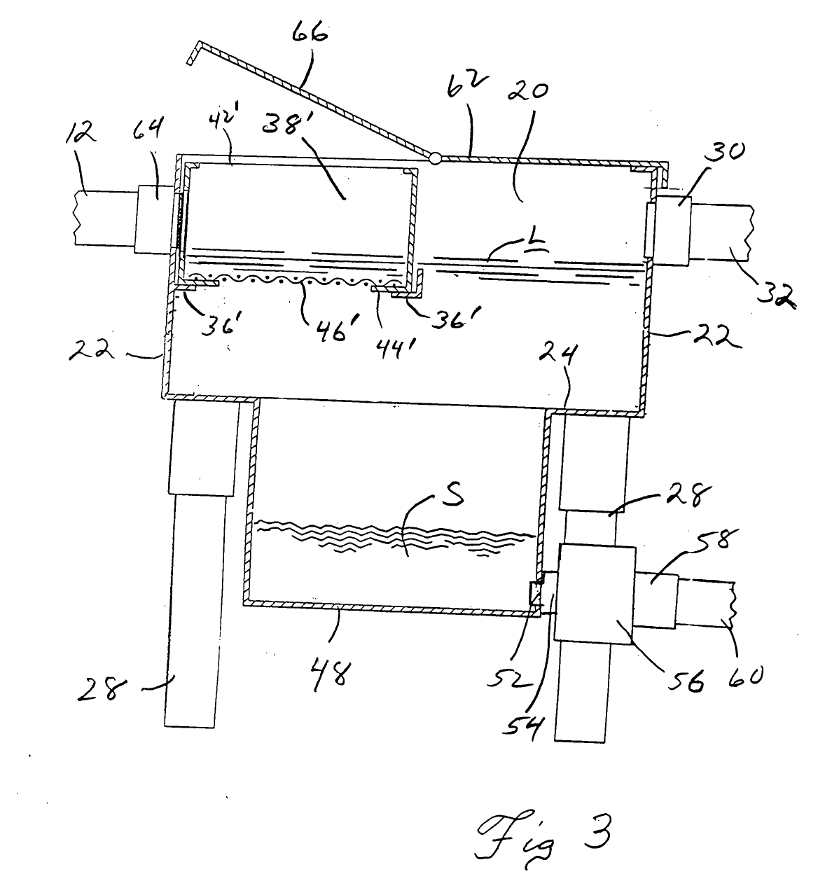

Means is provided to maintain a substantially constant, predetermiuned water level in the interior of the container housing. Baffle members 31 may, as shown, be arranged in position enclosing the outlet openings in order to maintain a predetermined desired level L of wastewater in the upper chamber and assure that wastewater discharged from the container through the outlet 30 is limited to only the top-most portion of the wastewater level L maintained in the upper chamber 20. Alternatively, the vertical position of the outlet opening 30 on the wall 22 may be arranged as needed to control and maintain the desired water level L within the chamber, as is illustrated in the embodiment of FIG. 3 of the drawings.

As shown best in FIG. 2, the upper chamber is arranged, as by support mounts 36, to receive and support a first solid particle collection apparatus, illustrated in this embodiment as a removable screen basket shown in the form of a slide-out drawer 38 supported above the predetermined water level L maintained in the interior of the housing. In this solids collection arrangement, the screen basket has closed side and end walls 40, an open top 42 and a bottom wall 44 having an opening therethrough covered by a fine mesh or perforated screen 46 provided with a perforation size selected to catch and prevent passage of fine and larger food particles and other solid particulates through the screen, as is readily apparent. As will be understood by those skilled in the art, the screen basket is arranged so that all wastewater passing into the housing cavity through the wastewater drain pipe 12 from rinse sinks and other discharge units is directed into the screen basket and allowed only to exit through the screen 46, thereby assuring that all larger solids carried with the wastewater are trapped and retained within the screen basket as the wastewater enters into the upper chamber area 20 of the container housing.

As will also be apparent to those skilled in the art, although the screen basket described hereinbefore is shown and described as a slide-out drawer structure 38 arranged so that it may be removed for convenient discard of collected solids by sliding the drawer horizontally out of the interior cavity of the housing body, this is merely one illustrative embodiment of a solids screening and containment arrangement, and other screen arrangements may be provided as an alternative. For example, as can be understood in viewing FIG. 2 of the drawings, the screen basket 38 may if desired alternatively be arranged to be lifted vertically out of the housing body cavity through the open top end thereof. Still other solid particle collection arrangements may be provided as alternative, as will also be discussed in connection with the embodiment of the strainer apparatus shown in FIG. 3 of the drawings.

Both unique to and critically important to the solids strainer apparatus of this invention is the specific arrangement of the container housing to include a second, lower, solids and semi-solid material collection chamber 48 in the form of a sump or well underlying and adjoining the upper settling chamber 20 and open to the upper chamber through the bottom 24 of the upper chamber and disposed to extend downwardly from the bottom of the upper chamber, as seen clearly in FIGS. 1, 2 and 3 of the drawings. Thus, from the foregoing and in viewing FIG. 2 of this embodiment of the invention it will be readily apparent that the interior cavity of the container housing maintains a volume of wastewater completely filling the lower, sump chamber 48 above the level of any solid and semi-solid material accumulated therein, and partially filling the upper chamber 20 to a predetermined, substantially-filled level L as shown.

Clearly, as additional wastewater is delivered into the cavity through drain pipe 12, the upper surface of the maintained water level L will rise and overflow the level-regulating baffle member 31, or other level-maintaining arrangement, whereupon the uppermost surface area of the water will pass through the outlet 30 and discharge pipe 32 into the grease trap assembly 16. As is well understood by those skilled in this art, since grease, oil and fats float on the wastewater, the wastewater exiting the container through outlet pipe 32, always the uppermost portion of the wastewater contained in the upper chamber, is laden substantially only with the grease, oils and fats naturally having floated to the surface. Fine solids and viscous, heavier-than-water semi-solids such as uncooked or raw cake, pancake, waffle and frying batters, and other heavier or dense food particles and particulate materials, such as coffee grounds, etc., small enough to have passed through the screen 46 in the screen basket 38, immediately sink through the wastewater contained in the housing and gravitate downwardly by gravity and settle at the bottommost end of the lower, solids collection sump chamber 48 as is readily apparent and shown by the accumulated solids S in the drawings.

For this reason the sump is provided with means for removing accumulated solid and semi-solid material S that has settled in the bottom of the sump over a period of time as determined by the particular facility output and its particular needs. One such removal means is shown in FIG. 2 wherein the sump 48 is provided with a lift-out strainer basket, illustrated in this embodiment as a flexible bag member 50 formed of a fine mesh, water permeable fabric material selected to permit the easy passage of water therethrough but not the passage of the solids S settled therein, not unlike the construction of a coffee filter.

In this manner on a periodic maintenance basis, with the screen drawer 38 removed from the upper chamber for emptying of collected solid particles, the bag 50 may be lifted upwardly from the sump and raised above the water level L in the upper chamber 20 and allowed to drain of water contained therein. The bag 50 may either be discarded in the trash and replaced with a fresh bag or the contents of the bag may be emptied into a trash receptable and the bag then returned to the sump for reuse. The bag may be provided with a lifting ring (not shown), a handle (not shown) or other structural arrangement suitable for facilitating the lifting of the bag as will be readily apparent.

Although the sump basket 50 is illustrated and described herein as a fabric bag member 50, it will also be recognized that a strainer basket member could alternatively be provided in other forms including, but not limited to rigid strainer constructions formed of plastic, metal or other materials and configured for the aforementioned purpose and function.

FIG. 3 of the drawings illustrates examples of some various modifications of various structural elements of the apparatus described hereinbefore as shown in connection with the embodiment of FIGS. 1 and 2. For example, FIG. 3 illustrates yet another suitable means for removing accumulated solids and semi-solid material S from the collection sump 48 as an alternative to the aforementioned lift-out strainer basket arrangements previously described and shown in FIG. 2. In this regard, the lift-out container arrangement 50 is entirely omitted, and as illustrated in FIG. 3, the lower, sump chamber 48 is provided with an outlet fixture 52 positioned adjacent a lowermost portion of the sump. The outlet fixture is arranged to communicate the interior of the sump with the inlet 54 of a selected, powered pump 56. The outlet 58 of the pump may in turn communicate with a discharge drain pipe 60 connected to the wastewater drain pipe 18 of the drain system of the facility downstream of and bypassing the grease trap apparatus 16. Alternatively, the outlet 58 of the pump 56 may be arranged to discharge pumped material to a collection container (not shown) if so desired or needed.

The operation of the pump unit 56 may be controlled by timer (not shown) arranged to periodically activate the unit on a predetermined, set schedule. Alternatively, the pump may be provided for operation by a manual activation switch (not shown) operable by a user as needed, or by any other means as may be determined to be suitable. As will be apparent, the pump 56 may, if desired, alternatively comprise a submerged, well or sump-type pump positioned within the interior confines of the sump chamber and having an outlet communicating through outlet fixture 52, for pumped discharge of material from the interior confines of the strainer apparatus, as can be readily appreciated.

In any case, the duration of the pump's activation is preferably automatically controlled or limited, as by timer or other controller (not shown), that is preset to limit operation of the pump to a duration selected to remove only the lower portion of the volume of solid material collected in the sump, in order to insure that substantially only the solid material pumped out of the sump portion of the housing, and not any grease, fat and oil-laden wastewater contained in the apparatus, particularly if the pump discharges to the drain system behind and by passing the grease trap apparatus of a facility.

FIG. 3 also illustrates that the strainer apparatus 10 of this invention may be arranged for disposition other than beneath a rinse sink 14 as shown in FIG. 1. FIG. 3 also shows that the open top of the earlier-described strainer apparatus may be covered if desired by a top cover lid member 62. Also, the apparatus may be arranged to support connection of the drain pipe 12 through a side wall 22 provided with an inlet connector 64 as shown in FIG. 3.

Also shown is an alternative embodiment of a removable screen basket, previously discussed in connection with the slide out drawer 38 configuration of a solids collection screen apparatus illustrated in FIGS. 1 and 2. This embodiment illustrates a lift out screen basket 38′ which, similar to the earlier described screen drawer arrangement 38, is supported in the upper chamber on suitable support mounts 36′ and has enclosing side and end walls 40′, an open top end 42′ and open bottom 44′ with perforate screen member 46′ as is apparent. For convenience in facilitating the removing and replacing of the lift out basket 38′, the top lid 62 of the housing apparatus may be provided with an access door 66 as shown.

As also briefly mentioned earlier, FIG. 3 also illustrates that the outlet fixture 30 may if desired be positioned vertically higher on a side wall 22 if desired in order to maintain a higher retained water level L within the upper chamber. In this regard, as shown in FIG. 3, the water level L may be maintained at a higher level than the level of the perforate screen 46, 46′ of the upper screen basket 38, 38′. This arrangement provides for an effective water buffer for protecting food particles and solid particulates that are trapped by the screen 46, 46′ against direct impact from incoming wastewater through drain pipe 12. This arrangement serves to prevent erosion and breakdown of such food particles into a condition in which they could be forced through or passed through the perforations of the screen and eventually possibly make their way to the grease trap assembly.

From the foregoing it will be apparent to those skilled in the art that the strainer apparatus of this invention serves to effectively separate solids from waste water both by trapping larger solid particles by the screen basket arrangement 38, 38′ and by providing for the settling of heavier, solid and semi-solid, viscous materials from the volume of wastewater. This effectively provides for substantially only grease, oil and fat laden wastewater to flow out of the outlet of the strainer apparatus and into the grease trap apparatus of the facility, and thereby eliminate or substantially reduce the possibility of accumulation of undesirable solids in the grease trap assembly. The result is a great reduction in the ongoing maintainance and maintainance cost associated with the normal operation of grease trap assemblies in commercial kitchen and food preparation facilities.

From the foregoing it will also be apparent to those skilled in the art that many various changes, other than those already described and discussed hereinbefore, may be made in the size, shape, type, number and arrangement of parts described hereinbefore without departing from the spirit of this invention and the scope of the appended claims.

Having thus described my invention and the manner in which it may be used, I claim:

1. A wastewater solids strainer apparatus for removing solid particles and heavier-than-water semi-solid materials from wastewater passing through the apparatus, the wastewater solids strainer apparatus comprising:
a) a container housing having a substantially hollow interior cavity defining a first upper, solids separation and gravitation chamber and a second, underlying lower, semi-solid material collection sump chamber having an interior open to the bottom of said upper chamber, said interior cavity arranged to maintain wastewater therein at a predetermined level in said upper chamber,
b) a housing inlet arranged for communicating wastewater into said upper chamber,
c) a housing outlet in the upper chamber and arranged to communicate wastewater out of the housing from the top of said water level in the upper chamber, and
d) means for removing semi-solid material collected in said semi-solid material collection sump chamber from the container housing.

2. The solids strainer apparatus of claim 1 including a solid particle collection screen apparatus in said upper chamber, said solids collection screen apparatus including a perforate screen member, the solid particle collection screen apparatus arranged to communicate wastewater from said housing inlet to the upper chamber through said perforate screen member,

3. The solids strainer apparatus of claim 2 wherein said solid particle collection screen apparatus comprises a screen basket member removably supported in said upper chamber and arranged for removal from the container housing for discard of solid particles collected therein.

4. The solids trainer apparatus of claim 3 wherein said screen basket member is arranged as a slide out drawer member removably supported on the container housing.

5. The solids strainer apparatus of claim 3 wherein said screen basket member is arranged as a lift out basket member removably supported on the container housing.

6. The solids strainer apparatus of claim 1 wherein said means for removing semi-solid material comprises a lift out container member arranged to be removably supported in the interior of the lower, material collection sump chamber.

7. The solids strainer apparatus of claim 1 wherein said means for removing semi-solid material comprises a powered pump having an inlet communicating with the interior of the sump and selectively operable to pump semi-solid material collected in the interior of the sump out of the container housing.
